(19) United States
(12) Patent Application Publication
(10) Pub. No.: US 2019/0070820 A1
(43) Pub. Date: Mar. 7, 2019

(54) TRIANGLE SANDWICH PACKAGING MACHINE AND METHOD OF PACKAGING TRIANGLE SANDWICH

(71) Applicants: GENERAL PACKER CO., LTD., Aichi (JP); KABUSHIKI KAISHA YASKAWA DENKI, Kitakyushu-shi (JP)

(72) Inventors: Tomohiro Noda, Kitanagoya-shi (JP); Tomoya Hyodo, Kitakyushu-shi (JP); Haruhiko Koike, Kitakyushu-shi (JP); Tomohiro Kamishio, Kitakyushu-shi (JP); Teruhisa Kitagawa, Kitakyushu-shi (JP); Koichi Kirihara, Kitakyushu-shi (JP)

(73) Assignees: GENERAL PACKER CO., LTD., Aichi (JP); KABUSHIKI KAISHA YASKAWA DENKI, Kitakyushu-shi (JP)

(21) Appl. No.: 16/119,139

(22) Filed: Aug. 31, 2018

(30) Foreign Application Priority Data
Sep. 6, 2017 (JP) 2017-171063

(51) Int. Cl. B31B 70/00; B65B 5/04; B65B 43/30

(52) U.S. Cl. CPC B31B 70/001; B65B 5/045; B31B 2160/30; B31B 70/003; B65B 43/30

(57) ABSTRACT

A triangle sandwich packaging machine includes paired grips for holding vicinities of both sides of a bag mouth of a triangle sandwich packaging bag, a mover intermittently moving the paired grips in every one of packaging stations, and a spatula inserting mechanism for forming a crest on the triangle sandwich packaging bag held by the paired grips to shape an opening. Also provided is a triangle sandwich packaging method including a moving step of intermittently moving the paired grips holding the triangle sandwich packaging bag in every one of the packaging stations, an opening step of opening the triangle sandwich packaging bag into a sectorial shape and a spatula inserting step of forming a crest on the triangle sandwich packaging bag held by the paired grips to shape an opening and inserting a spatula for shaping the opening.

### CROSS-REFERENCE TO RELATED APPLICATIONS

This application is based upon and claims the benefit of priority from the prior Japanese Patent Application No. 2017-171063 filed on Sep. 6, 2017, the entire contents of which are incorporated herein by reference.

### BACKGROUND

### 1. Technical Field

The present disclosure relates to a triangle sandwich packaging machine which packs triangle sandwiches in a triangle sandwich packaging bag and a method of packaging the triangle sandwich.

### 2. Related Art

In packaging triangle sandwiches, works up to packing triangle sandwiches in triangle sandwich packaging bags with a special shape have conventionally been carried out by hand work, and only a sealing process is automatically carried out. For example, refer to Japanese Patent No. 4355951 and Japanese Patent No. 6105505.

One of the causes for impeding automatization of the works up to the packing process is that a sandwich has a large size and is steric and soft relative to the specially shaped triangle sandwich packaging bag into which the sandwich is to be put, with the result that it is difficult to expertly pack the sandwich in the packaging bag in the packaging machine.

### SUMMARY

Therefore, an object of the present disclosure is to provide a triangle sandwich packaging machine and a method of packaging the triangle sandwich, which machine and method can pack the triangle sandwich in the specially shaped triangle sandwich packaging bag.

The disclosure provides a triangle sandwich packaging machine including paired grips provided for holding vicinities of both sides of a bag mouth of a triangle sandwich packaging bag, a mover intermittently moving the paired grips in every one of packaging stations, and a spatula inserting mechanism provided for forming a crest on the triangle sandwich packaging bag held by the paired grips to shape an opening.

The disclosure also provides a method of packaging a triangle sandwich by a triangle sandwich packaging machine including paired grips provided for holding vicinities of both sides of a bag mouth of a triangle sandwich packaging bag, a mover intermittently moving the paired grips in every one of packaging stations, and a spatula inserting mechanism provided for forming a crest on the triangle sandwich packaging bag held by the paired grips to shape an opening. The method includes a moving step of intermittently moving the paired grips holding the triangle sandwich packaging bag in every one of the packaging stations, an opening step of opening the triangle sandwich packaging bag into a sectorial shape, and a spatula inserting step of forming a crest on the triangle sandwich packaging bag held by the paired grips to shape an opening and inserting a spatula for shaping the opening.

Since the crest is formed on the triangle sandwich packaging bag, the triangle sandwich can be expertly put into the triangle sandwich packaging bag without being forcedly pressed, with the result that the triangle sandwich can be packed in the specially shaped triangle sandwich packaging bag.

According to the method of packaging the triangle sandwich, the crest is formed on the triangle sandwich packaging bag, whereby the triangle sandwich can be expertly put into the triangle sandwich packaging bag without being forcedly pressed, with the result that the triangle sandwich can be packed in the specially shaped triangle sandwich packaging bag.

The spatula inserting mechanism may have a plurality of spatulas each configured to be openable and closable. Since the spatulas are openable and closable in the triangle sandwich packaging bag, the spatulas can be prevented from being caught by the vicinities of the bag mouth when the spatulas are inserted through the bag mouth of the triangle sandwich packaging bag, and the crest can be reliably formed on the triangle sandwich packaging bag.

### BRIEF DESCRIPTION OF THE DRAWINGS

In the accompanying drawings:

FIG. 1 is a schematic plan view of a triangle sandwich packaging machine of one embodiment;

FIG. 2 is a schematic front view of the triangle sandwich packaging machine;

FIG. 3 is an illustration diagram to explain packaging processes executed by the triangle sandwich packaging machine as illustrated in FIG. 1;

FIGS. 4A and 4B are respectively a schematic left side view and a schematic front view of a triangle sandwich packaging bag cutting mechanism of a bag feeder disposed at a bag feed station of the triangle sandwich packaging machine;

FIG. 5 is an illustration diagram to explain the working of the triangle sandwich packaging bag cutting mechanism;

FIGS. 6A and 6B are respectively a schematic left side view and a schematic front view of the triangle sandwich packaging bag cutting mechanism to explain the working of the mechanism;

FIG. 7 is an illustration diagram to explain the working of the triangle sandwich packaging bag cutting mechanism;

FIG. 8 is an illustration diagram to explain the workings of the triangle sandwich packaging bag cutting mechanism and a triangle sandwich packaging bag positioning and delivering mechanism;

FIG. 9 is an illustration diagram to explain the workings of the triangle sandwich packaging bag cutting mechanism and the triangle sandwich packaging bag positioning and delivering mechanism;

FIGS. 10A, 10B and 10C are respectively schematic left side views of the triangle sandwich packaging bag cutting mechanism to explain the working of the mechanism, and FIG. 10D is a schematic front view of the triangle sandwich packaging bag cutting mechanism to explain the working of the mechanism;

FIGS. 11A and 11B are respectively a schematic left side view and a schematic front view of the triangle sandwich packaging bag positioning and delivering mechanism to explain the working of the mechanism;

FIGS. 12A and 12B are respectively a schematic front view and a schematic right-side view of the triangle sandwich packaging bag positioning and delivering mechanism to explain the working of the mechanism;

FIGS. 13A and 13B are respectively a schematic front view and a schematic right-side view of the triangle sandwich packaging bag positioning and delivering mechanism to explain the working of the mechanism;

FIGS. 14A and 14B are respectively a schematic front view and a schematic right-side view of the triangle sandwich packaging bag positioning and delivering mechanism to explain the working of the mechanism;

FIG. 15 is an illustration diagram to explain the working of the triangle sandwich packaging bag positioning and delivering mechanism;

FIG. 16 is an illustration diagram to explain the working of the triangle sandwich packaging bag positioning and delivering mechanism;

FIGS. 17A and 17B are respectively a schematic left side view and a schematic front view of an opening suction mechanism of the bag feeder disposed at the bag feed station of the triangle sandwich packaging machine to explain the mechanism;

FIGS. 18A and 18B are respectively a schematic left side view and a schematic front view of an opening suction mechanism of the bag feeder disposed at the bag feed station of the triangle sandwich packaging machine to explain the working of the mechanism;

FIGS. 19A and 19B are respectively a schematic left side view and a schematic front view of a paddle insertion mechanism of the triangle sandwich packaging machine to explain the mechanism;

FIG. 20 is an illustration diagram to explain the working of the paddle insertion mechanism;

FIGS. 21A and 21B are respectively a schematic left side view and a schematic front view of the triangle sandwich packaging machine to explain a process of packing triangle sandwich in the packaging bag;

FIGS. 22A and 22B are respectively a schematic left side view and a schematic front view of the triangle sandwich packaging machine to explain the process of packing triangle sandwich in the packaging bag;

FIGS. 23A and 23B are respectively a schematic left side view and a schematic front view of the triangle sandwich packaging machine to explain the process of packing triangle sandwich in the packaging bag;

FIGS. 24A and 24B are respectively a schematic left side view and a schematic front view of the triangle sandwich packaging machine to explain the process of packing triangle sandwich in the packaging bag;

FIG. 25 is a schematic plan view of a grip width adjusting mechanism of the triangle sandwich packaging machine as illustrated in FIG. 1 to explain the mechanism;

FIG. 26 is an illustration diagram to explain a packing inspection process in the triangle sandwich packaging machine as illustrated in FIG. 1;

FIG. 27 is an illustration diagram to explain a discharge process in the triangle sandwich packaging machine as illustrated in FIG. 1; and

FIGS. 28A and 28B are respectively a schematic front view and a schematic right-side view of a triangle sandwich packaging bag filled with sandwiches in the triangle sandwich packaging machine as illustrated in FIG. 1 to explain the packaging bag.

### DETAILED DESCRIPTION

According to one embodiment, a triangle sandwich packaging machine includes a pair of grips 3 holding vicinities of two sides of a bag mouth c of a triangle sandwich packaging bag a, a mover 4 configured to intermittently move the paired grips 3 in every one of a plurality of packaging steps, and a spatula inserting mechanism 7 for forming a crest on the triangle sandwich packaging bag a held by the paired grips 3 and adjusting an opening shape. As the result of the construction, a triangle sandwich Z can be expertly inserted into the triangle sandwich packaging bag a without being forcedly pressed against the triangle sandwich packaging bag a thereby to be packaged in the triangle sandwich packaging bag a with a special shape.

According to another embodiment, a method of packaging a triangle sandwich by a triangle sandwich packaging machine including a pair of grips 3 provided for holding vicinities of both sides of a bag mouth of a triangle sandwich packaging bag, a mover 4 configured to intermittently move the paired grips 3 in every one of packaging stations, and a spatula inserting mechanism 7 provided for forming a crest on the triangle sandwich packaging bag held by the paired grips 3 to shape an opening. The method includes a moving step of intermittently moving the paired grips holding the triangle sandwich packaging bag in every one of the packaging stations, an opening step of opening the triangle sandwich packaging bag into a sectorial shape, and a spatula inserting step of forming a crest on the triangle sandwich packaging bag held by the paired grips 3 to shape an opening and inserting a spatula for shaping the opening.

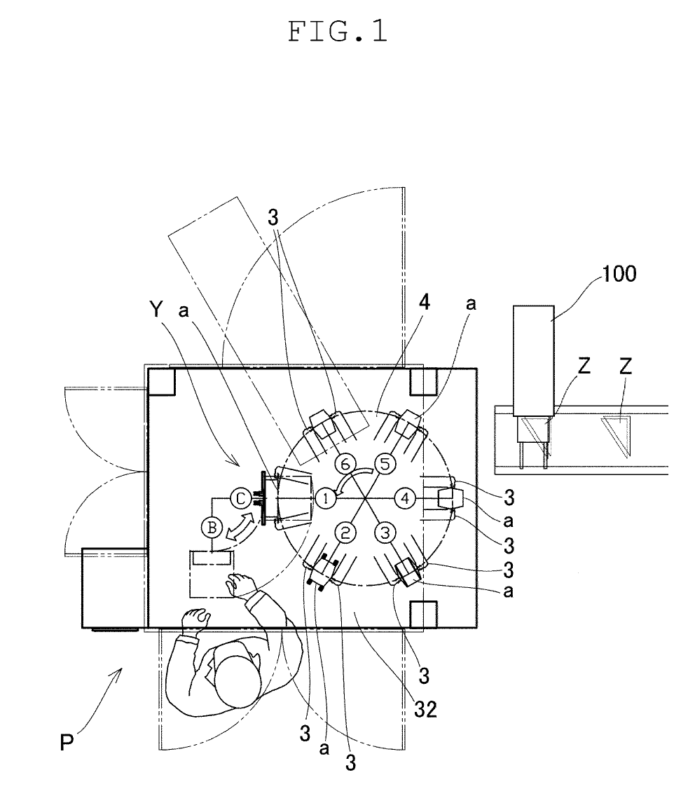

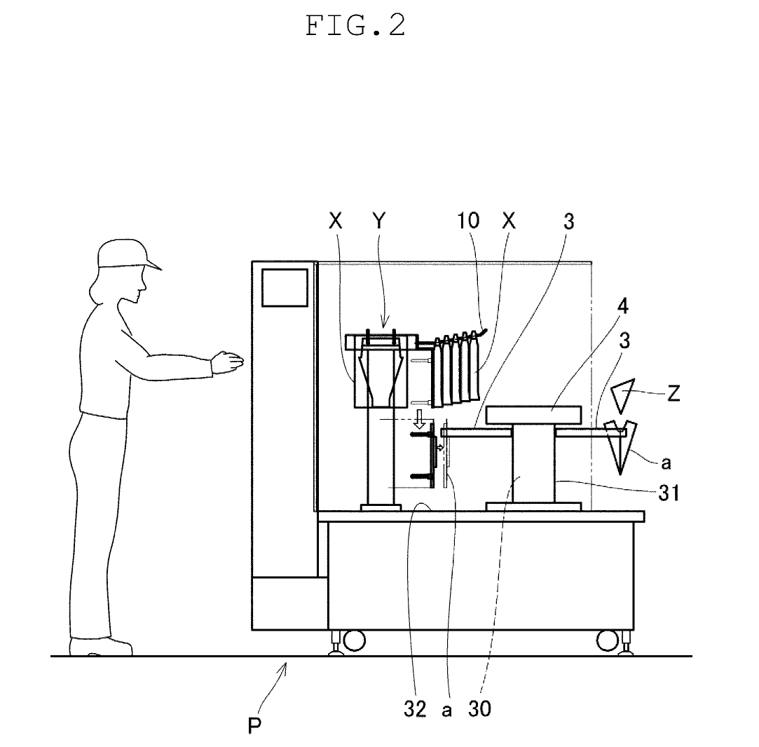

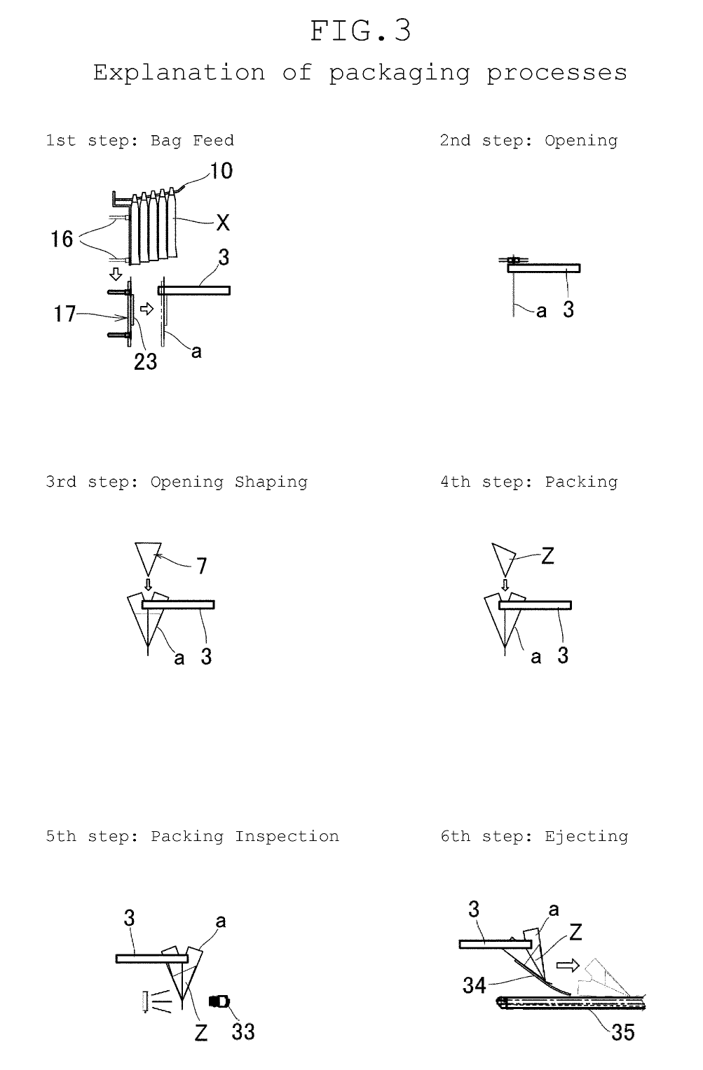

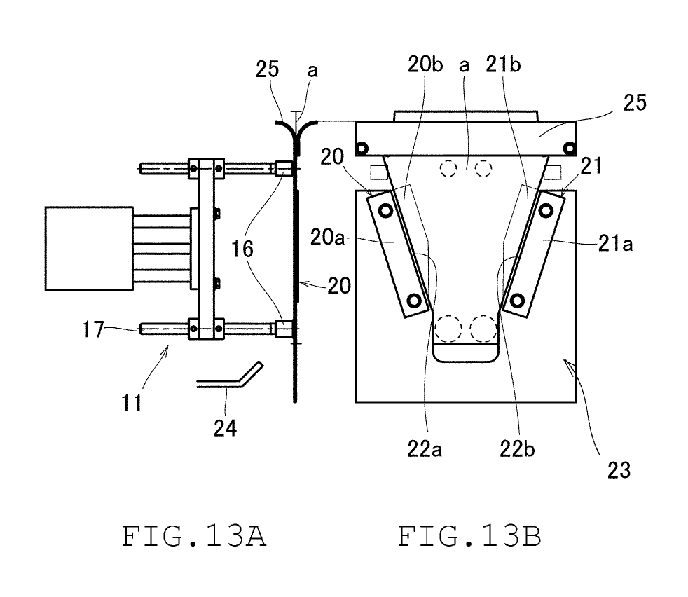

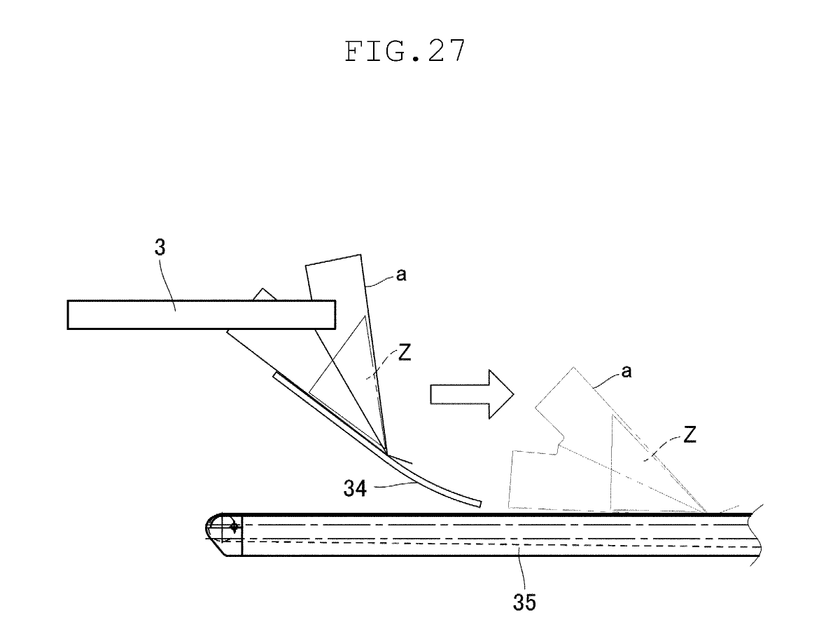

An embodiment will be described with reference to FIGS. 1 to 28B. A triangle sandwich packaging machine P of the embodiment includes a pair of grips 3 holding vicinities of two opposite sides of a bag mouth c of a triangle sandwich packaging bag a, a mover 4 configured to intermittently move the paired grips 3 in every one of a plurality of packaging steps, an opening suction mechanism 5 for suctioning the packaging bag a held by the paired grips 3 from inside and outside the packaging bag a thereby to sectorially open the packaging bag a, a grip width adjusting mechanism 6 capable of adjusting an intergrip distance of the paired grips 3 in the insertion of the triangle sandwich Z into the packaging bag a held and sectorially opened by the paired grips 3, and a spatula inserting mechanism 7 for forming a crest on the packaging bag a held by the paired grips 3 and adjusting an opening shape. Each of the aforementioned configurations will be sequentially described in detail.

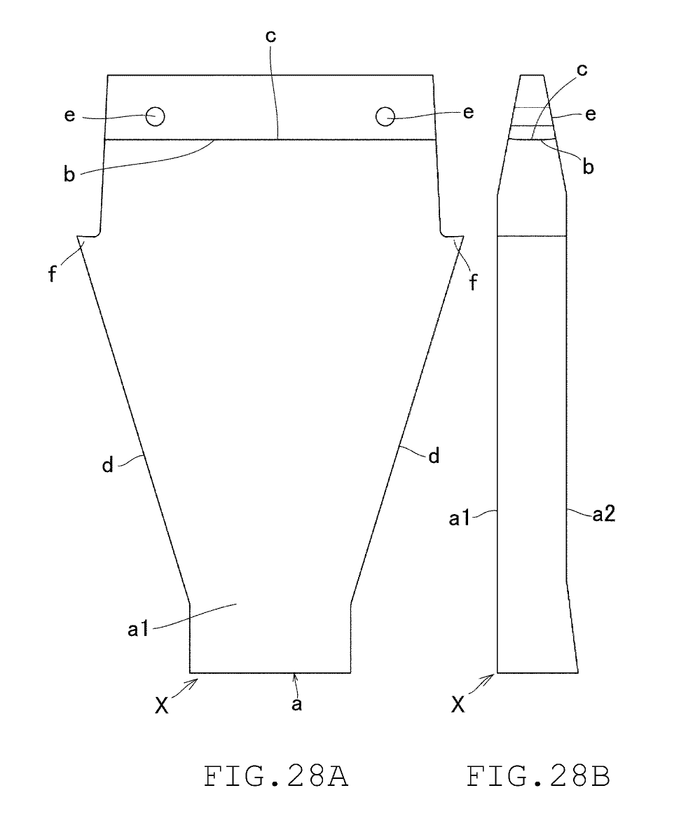

In the packaging machine P of the embodiment, the packaging bag a into which the triangle sandwich Z is inserted to fill the bag has a front shape as illustrated in FIG. 28A.

More specifically, the packaging bag a is formed of an obverse side resin sheet a1 and a reverse side resin sheet a2 into a bag shape, both of which sheets a1 and a2 have the same configuration. The packaging bag a has two side inclined parts d having respective lateral (horizontal) parts whose widths are gradually reduced downward.

The packaging bag a is provided with a perforation b extending laterally (horizontally) on an upper part thereof and two through holes e located away from each other in the lateral (horizontal) direction above the perforation b. When an upper part of the packaging bag a is cut off along the perforation b, a bag mouth c appears at an upper end. The packaging bag a is configured so that a triangle sandwich is insertable through the bag mouth c or to be capable of being filled with a triangle sandwich. Furthermore, both sides of uppermost parts of the side inclined parts d respectively constitute grip holding parts f held by the paired grips 3.

A large number of the above-described packaging bags a (200 in the embodiment) are bundled into a bag bundle X of the packaging bags a, as illustrated in FIG. 28B.

The packaging machine P of the embodiment receives the packaging bag a from a bag feeder Y and opens the bag mouth c of the packaging bag a in order to pack the triangle sandwich Z in the packaging bag a. As illustrated in FIGS. 1 to 3, the packaging machine P is constructed to respectively carry out first to sixth steps at first to sixth stations.

More specifically, a bag feed step (a first step) of feeding the packaging bags a to the packaging machine side one by one is carried out at the first station. An opening step (a second step) of opening the bag mouth c provided at the upper end of the packaging bag a is carried out at the second station. An opening shaping step (a third step) of shaping an opening of the packaging bag a is carried out at the third station. A packing step (a fourth step) of packing the triangle sandwich Z into the packaging bag a is carried out at the fourth station. A packing inspection step (a fifth step) of inspecting the triangle sandwich Z packed in the packaging bag a is carried out at the fifth station. An ejecting step (a sixth step) of ejecting the packaging bag a filled with the triangle sandwich Z outside the machine is carried out at the sixth station.

Although the packaging machine P of the embodiment is of the rotary type, the invention may be applied to a known linear travelling type packaging machine. The linear travelling type packaging machine includes a mover horizontally moving along an annular passage comprising a linear part and semicircular parts respectively located at both ends of the linear part. A number of paired grips are provided on the mover so as to be changeable between a vertical posture and a horizontal posture. The packaging bag is intermittently stopped at each one of an opening step of supporting by the paired grips the packaging bag a fed at the bag feed step, a packing step and the like and intermittently stopping the packaging bag at each of the steps including the opening step, the packing step to pack an article into the packaging bag.

In the packaging machine P, a stand 31 is provided on a machine base 32 to rotatably support an intermittent rotation shaft 30 extending in the vertical direction. Six pairs of grips 3 are provided on the mover 4 (a disc rotator) mounted on an upper part of the intermittent rotation shaft 30 so as to radially project at regular intervals about the intermittent rotation shaft 30. The grips 3 are provided for gripping and releasing the packaging bag a. The packaging bag a is taken by a bag supply device Y in the bag supply step (the first step). The packaging bag a is supported in a suspended state in a vertical posture by the paired grips 3 intermittently moved to the bag supply station sequentially.

Feed of the packaging bags a to the bag feeder Y is carried out by manually supplying the bag bundle X of the packaging bags a to part B in FIG. 1 during stop of the machine. Upon completion of supply to the part B, a cover (not illustrated) is closed and a button (not illustrated) is pressed so that the bag bundle X is transferred to part C in FIG. 1. Subsequently, the packaging machine P is started so that the packaging bags a are sequentially supplied from the bag feeder Y to the packaging machine P. When all the packaging bags a of the bag bundle X have been supplied, the packaging machine P is stopped, and the part B is returned. After having been supplied to part B, the bag bundle X of the packaging bags a is transferred to part C.

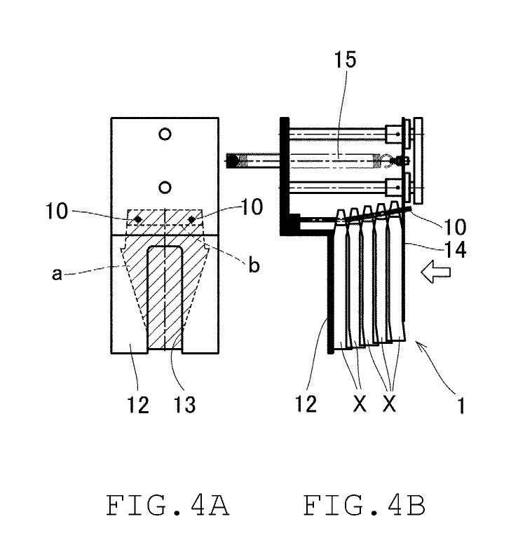

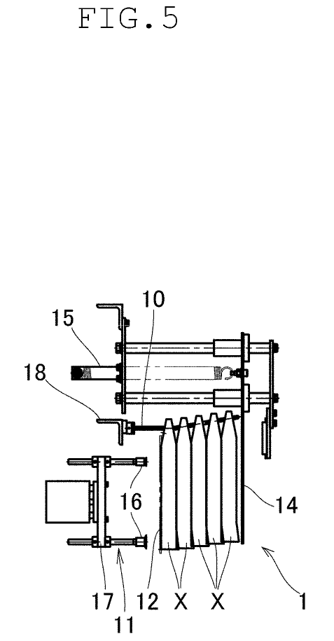

The bag feeder Y includes a triangle sandwich packaging bag cutting mechanism 1 for cutting the packaging bags a one by one along the perforation b from the bag bundle X. As illustrated in FIGS. 4B and 5, the packaging bag cutting mechanism 1 includes bag bundle suspending supports 10 which are respectively inserted through the through holes e of the packaging bags a to support the bag bundle X in a suspended state and a suction mechanism 11 which suctions the packaging bag a from the bag bundle X supported by the bag bundle suspending supports 10 to cut off the packaging bag a along the perforation b.

The bag bundle suspending supports 10 (bar-shaped bodies) are respectively inserted through the through holes e of the packaging bag a. In the embodiment, the bag bundle X composed of five packaging bags a is supported by the bag bundle suspending supports 10 in the suspended state (the state as illustrated in FIGS. 28A and 28B).

A foremost one of the packaging bags a supported by the bag bundle suspending supports 10 (a leftmost one in FIG. 4B) is in surface contact with a rear surface of the cutoff surface 12 as illustrated in FIG. 4A. The cutoff surface 12 has a suction cutout 13 for suctioning the packaging bag a located foremost (leftmost in FIG. 4B).

A rearmost one of the packaging bags a supported by the bag bundle suspending supports 10 (a rightmost one in FIG. 4B) is in contact with a pressing surface 14. When the bag bundle X of the five packaging bags a is pressed in the direction of the foremost one (to the left side in FIG. 4B) with the result that the foremost (leftmost as viewed in FIG. 4B) packaging bag a is cut off, the packaging bags a are sequentially moved to the foremost side (the left side as viewed in FIG. 4B). The pressing surface 14 is pulled toward the foremost side (the left side as viewed in FIG. 4B) by a spring member 15, so that a pressing force to be applied to the bag bundle X is generated in the direction of the foremost packaging bag a.

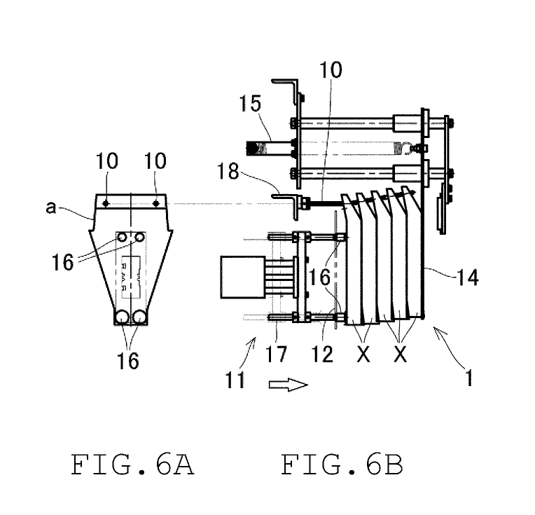

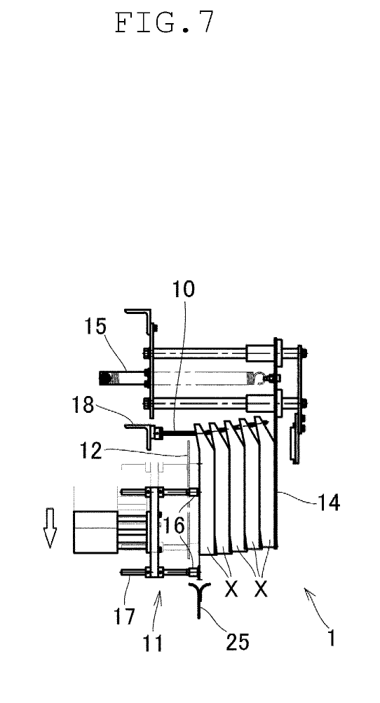

The suction mechanism 11 includes four suckers or two upper suckers and two lower suckers and a vertical and horizontal mover 17 movable in an up-down (vertical) direction and a right-left (horizontal) direction by an actuator (not illustrated), as illustrated in FIGS. 6A, 6B and 7. A vacuum pump (not illustrated) is controlled so that the mover 17 is moved downward with the packaging bag a being stuck by the suckers 16 thereby to cut off the packaging bag a from the bag bundle X.

The bag bundle suspending supports 10 extend to be movable downward toward the suction mechanism 11 as illustrated in FIG. 5. As a result, the packaging bags a of the bag bundle X sequentially come into contact with the cutoff surface 12 by the self-weight.

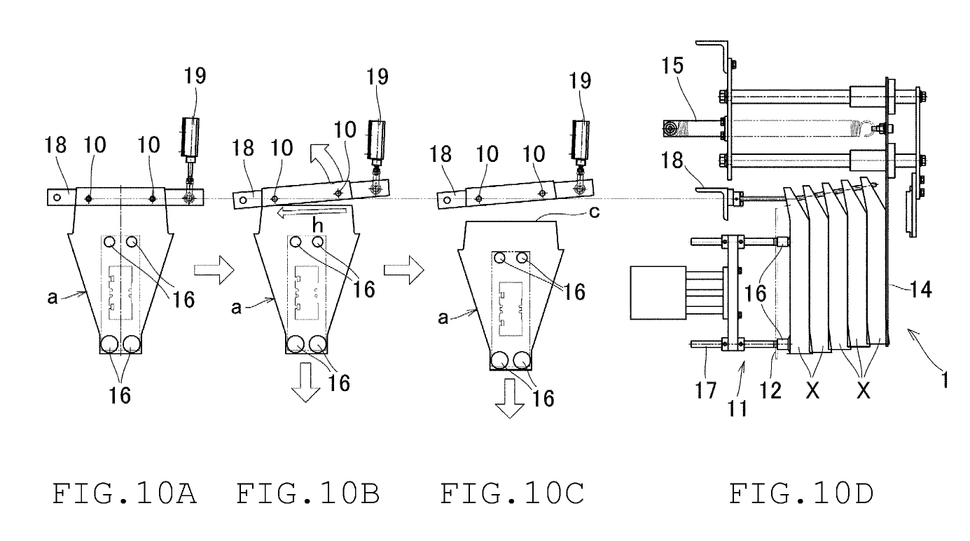

Furthermore, the bag bundle suspending supports 10 respectively have fixed ends, and a support fixing part 18 is provided to extend widthwise with respect to the bag bundle X supported by the bag bundle suspending supports 10. The support fixing part 18 is configured so that one side thereof is moved upward as illustrated in FIGS. 10A to 10D when the packaging bag a is downwardly suctioned by the suction mechanism 11 to be cut off. Consequently, since the bag bundle X is slanted, force can be concentrated on the perforation b with the result that the packaging bag a can be cut off easily and reliably. In the embodiment, as illustrated in FIG. 10B, the support fixing part 18 is coupled at one side to a cylinder head of a cylinder 19, so that the one side of the support fixing part 18 is moved upward relative to the other side. Along with this operation, the cut progresses in a direction h in FIG. 10B.

The following will specifically describe the operation of cutting off one packaging bag a from the bag bundle X by the above-described packaging bag cutting mechanism 1. First, the vacuum pump is turned on, and the suckers 16 of the suction mechanism 11 are brought into a suction state (the state as illustrated in FIGS. 5A-5D). Next, the vertical and horizontal mover 17 is moved to the cutoff surface 12 side, so that the suckers 16 are respectively inserted into the suction cutouts to suction the foremost packaging bag a (the leftmost packaging bag in FIG. 4B). In this state, as illustrated in FIG. 7, the vertical and horizontal mover 17 is lowered, so that one of the packaging bags a of the bag bundle X is cut off. The one side of the support fixing part 18 is moved upward relative to the other side by the cylinder 19 simultaneously with the downward movement of the mover 17, with the result that the cutoff can be carried out easily and reliably, as illustrated in FIGS. 10B and 10C.

Thus, since the bag feeder Y is provided with the above-described cutoff mechanism 1, the bag bundle X of the packaging bags a is installed above the position of bag supply to the packaging machine P, so that the packaging bag a can be cut off by a slight operation of drawing the packaging bag a downward.

Furthermore, since one side of the support fixing part 18 is raised or lowered when the packaging bag a is suctioned downward by the suction mechanism 11 to be cut off, the packaging bag a is slanted so that stress applied to the perforation b is increased, with the result that the cutoff can be carried out easily and reliably.

Furthermore, a plurality of bag bundles of the packaging bags a is suspended on the suspending support 10 by using the through holes e of the packaging bags a. As a result, a large number of packaging bags a can be stocked.

Furthermore, since the suspending support 10 is disposed aslant, the packaging bags a can be sequentially supplied to the cutoff surface 12 by the self-weight of the bag bundle X.

The bag feeder Y includes a triangle sandwich packaging bag positioning and delivering mechanism 2 which positions the packaging bags a cut off by the cutoff mechanism 1 and sequentially delivers the packaging bags a to the paired grips 3 intermittently moved to the bag supply station (the first station) of the packaging machine P. The positioning and delivering mechanism 2 includes positioning lock parts 20 and 21 respectively caused to abut against the side inclined parts d of the packaging bag a cut off by the cutoff mechanism 2 to move downward. The positioning and delivering mechanism 2 also includes a positioning plate 23 movable to deliver the packaging bag a to the paired grips 3 and an air-spray/suction mechanism 24 which separates the packaging bag a by the positioning plate 23 when the packaging bag a is delivered to the packaging machine side (the paired grips 3).

The positioning lock parts 20 and 21 are respectively caused to abut against the side inclined parts d of the packaging bag a cut off by the cutoff mechanism 2 to move downward, thereby positioning the packaging bag a.

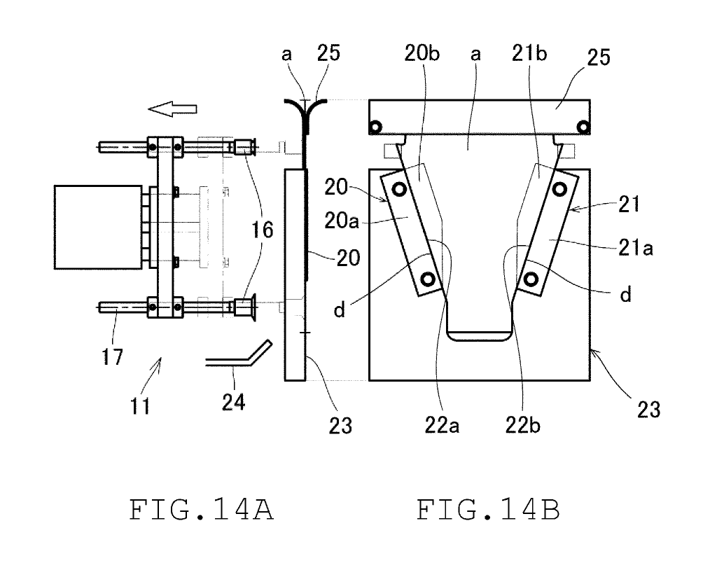

More specifically, the positioning lock parts 20 and 21 are provided on a rear surface of the positioning plate 23 and respectively have fixed-side pieces 20a and 21a and non-fixed-side pieces 20b and 21b in order that inclined parts having the same inclinations as the respective side inclined parts may be formed inside the packaging bag a, as illustrated in FIG. 14B. Locking inclined parts 22 (22a and 22b) are respectively formed on an inclined boundary between the fixed-side and non-fixed-side pieces 20a and 20b and an inclined boundary between the fixed-side and non-fixed-side pieces 21a and 21b. Both side inclined parts d of the packaging bag a are respectively caused to abut against the locking inclined parts 22 thereby to be locked.

The positioning plate 23 receives the packaging bag a cut off from the bag bundle X by the cutoff mechanism 2 to position the packaging bag a and delivers the packaging bag a to the paired grips 3. The positioning plate 23 has an insertion guide 25 formed into a Y-shape on an upper part thereof. The insertion guide 25 is movable in the right-left direction (the horizontal direction) by an actuator (not illustrated) such as a cylinder.

The air-spray/suction mechanism 24 is provided for separating the packaging bag a by the positioning plate 23 when the packaging bag a is delivered to the packaging machine side (the paired grips 3). In the embodiment, the mechanism is constructed of an air-spray mechanism comprising a compressor (not illustrated) and a nozzle.

Air is sprayed by the air-spray mechanism from the front side of the positioning plate 23 so that the packaging bag a is separated from the positioning plate 23 to be received by the paired grips 3.

Although the air-spray/suction mechanism 24 is constructed of the air-spray mechanism in the embodiment, a triangle sandwich packaging bag separating suction mechanism may be provided which suctions air from the rear side of the positioning plate 23 to separate the packaging bag a from the positioning plate 23 to deliver the packaging bag a to the paired grips 3.

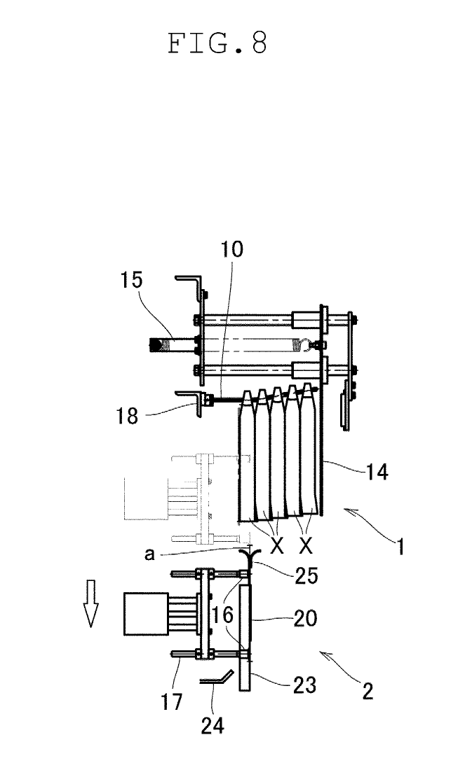

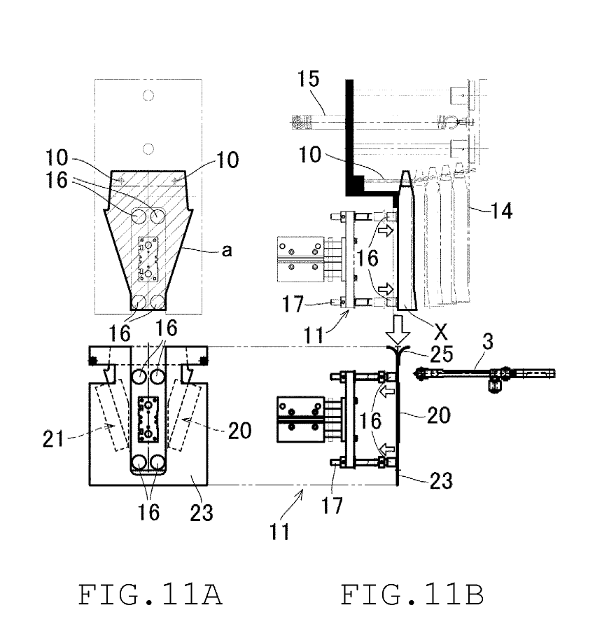

The working of the positioning/delivering mechanism 2 will be concretely described. When the mover 17 is moved downward with one packaging bag a being suctioned by the suckers 16 of the cutoff mechanism 1, the packaging bag a is inserted into the insertion guide 25 to be placed at the rear surface side of the positioning plate 23, as illustrated in FIGS. 8, 11A and 11B. With the insertion into the insertion guide 25, the vacuum pump is controlled to be turned off, so that the suckers 16 are released from the sucking state with the result that the packaging bag a freely falls in the positioning plate 23. The side inclined parts d of the packaging bag a freely falling are respectively caused to abut against the locking inclined parts 22 of the positioning lock parts 20 and 21 thereby to be locked and positioned at the rear surface side of the positioning plate 23.

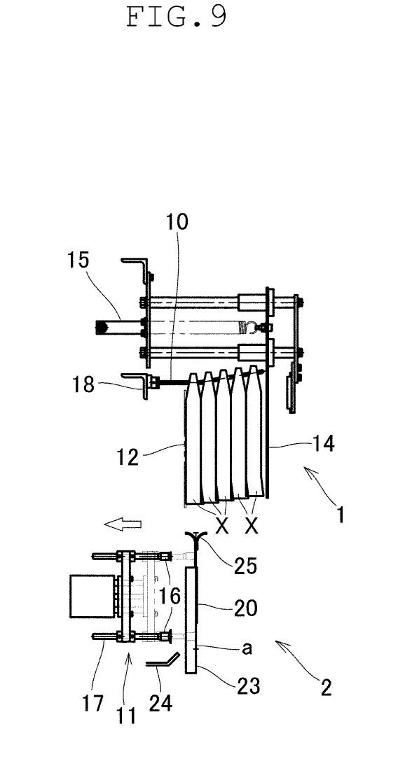

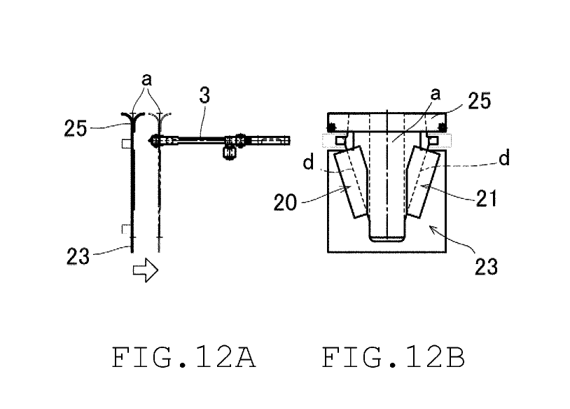

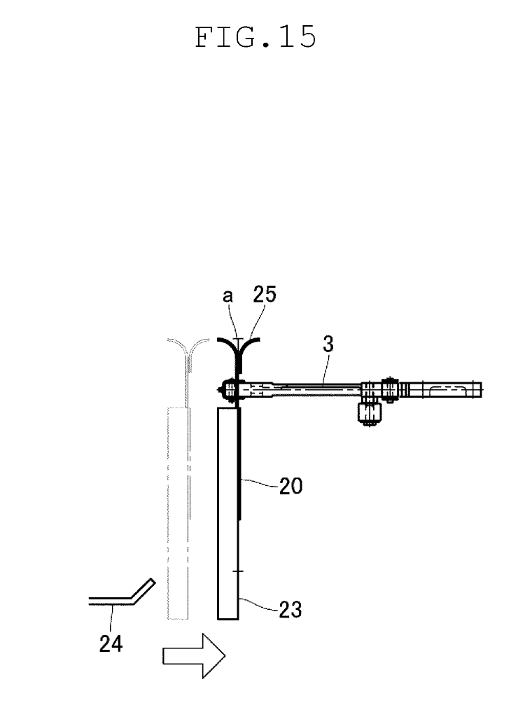

Next, as illustrated in FIGS. 9, 14A and 14B, the mover 17 is moved to the left side as viewed in FIGS. 9, 14A and 14B to depart from the positioning plate 23. The mover 17 is further moved to a location where the packaging bag a positioned and held by the positioning plate 23 can be delivered to the paired grips 3 intermittently moved to the bag supply station (a location where the paired grip holding parts f of the packaging bag a can be held by the paired grips 3), as illustrated in FIGS. 12A, 12B and 15.

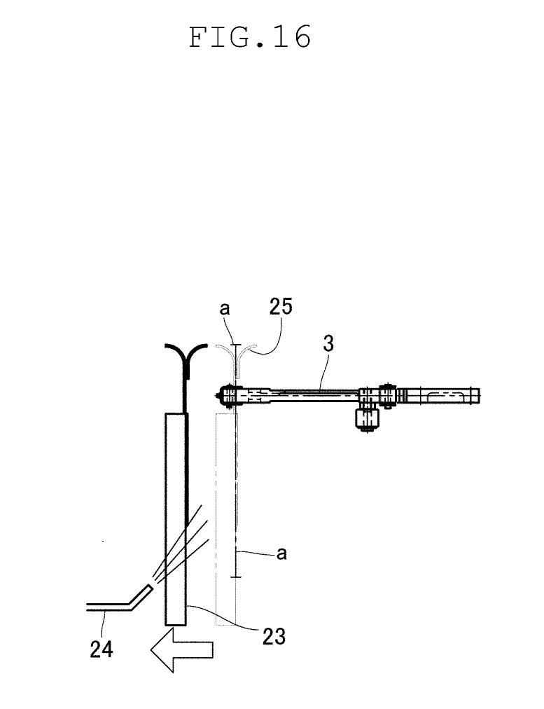

Air is sprayed by the air sprayer or suction mechanism 24 from the front side of the positioning plate 23 with the paired grip holding parts f being held by the paired grips 3, so that the packaging bag a is separated from the positioning plate 23 to be delivered, as illustrated in FIG. 16. After the packaging bag a has been separated from the positioning plate 23 to be delivered to the paired grips 3, the positioning plate 23 is returned to the initial position (the position where the positioning plate 23 receives the packaging bag a moved downward).

Thus, the packaging bag a cut off from the bag bundle X can be accurately positioned and delivered to the paired grips 3 by the positioning/delivering mechanism 2.

Upon receipt of the packaging bag a at the bag supply station of the packaging machine P, the paired grips 3 are intermittently moved to an opening station (a second station) where the opening step (the second step) is carried out. At the opening station, the opening suction mechanism 5 is provided for suctioning the packaging bag a held by the paired grips 3 from interior and exterior (both sides) to open the packaging bag a into the sectorial shape.

The opening suction mechanism 5 includes twelve suckers (six suckers in each side) and communication tubes 51 respectively communicating between the suckers 50 and a vacuum pump (not illustrated) and being reciprocable, and an actuator (not illustrated) rendering the communication tube 51 reciprocable.

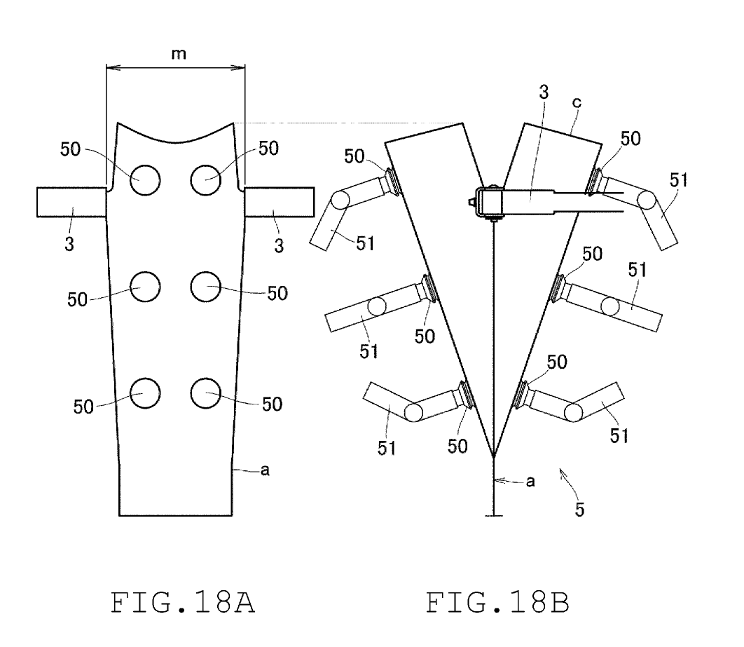

Six suckers 50 provided on each side are arranged so that a distance between the horizontally departing suckers 50 corresponds to a thickness of the packaging bag a so that the width of the opened packaging bag a becomes slightly larger than the thickness of the sandwich Z to be inserted (for example, slightly larger than the thickness of the sandwich Z), as illustrated in FIG. 18A. Furthermore, the reciprocable communication tube 51 is constructed so that a fulcrum shaft thereof is vertically reciprocable in a manner such that the communication tube does not block rotation of the mover (a circular disc). Furthermore, the opening mechanism 5 preferably has a position sensor (not illustrated) detecting the height of the packaging bag a.

The packaging bag a held by the paired grips 3 intermittently moved to the opening station (the second station) is configured to be suctioned from interior and exterior (front and back of the packaging bag a or the mover 4 side and the bag feeder Y side) and to be sectorially opened, as illustrated in FIG. 18B. As a result, even when the triangle sandwich Z to be inserted into the packaging bag a has a large size relative to the packaging bag a, the triangle sandwich Z can be smoothly put into the packaging bag a while the packaging bag a matches a triangular solid.

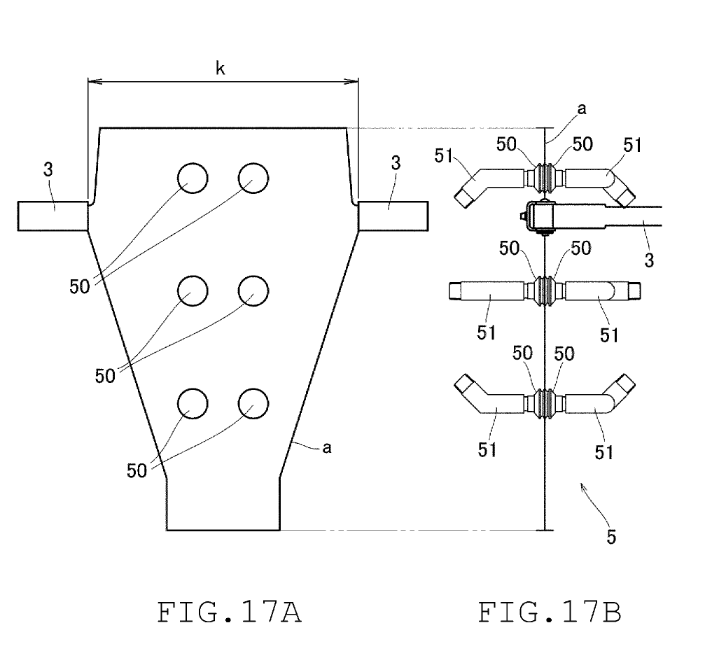

The packaging machine P includes the grip width adjusting mechanism 6 which can reduce the intergrip distance of the paired grips 3 from the value k in FIG. 17A to the value m in FIG. 18A when the packaging bag a held by the paired grips 3 is sectorially opened. As a result, the bag mouth c of the packaging bag a can be smoothly opened without damage to the packaging bag a.

The intergrip distance adjusting mechanism 6 comprises an intergrip distance adjusting cylinder 60 and a coordinating mechanism including an opening/closing plate 61 reciprocated in cooperation with the telescopic movement of a cylinder head 60a of the cylinder 60 and the paired grips 3.

More specifically, the paired grips 3 have a left holder 62a and a grip 62a provided on a distal end of the left holder 62a, and a right holder 63a and a grip 63a provided on a distal end of the right holder 63a. The holders 62a and 63a are respectively rotatable inward and outward about support points 64a and 64b provided at proximal end sides.

The proximal ends of the holders 62a and 63a are coupled together by a link 65 so that the holders 62a and 63a are coordinated during the intergrip distance adjustment. In other words, a grip opening/closing lever 66 is fixed to the right holder 63a and has a grip opening/closing roller 67 is provided to abut against the reciprocable opening/closing plate 61.

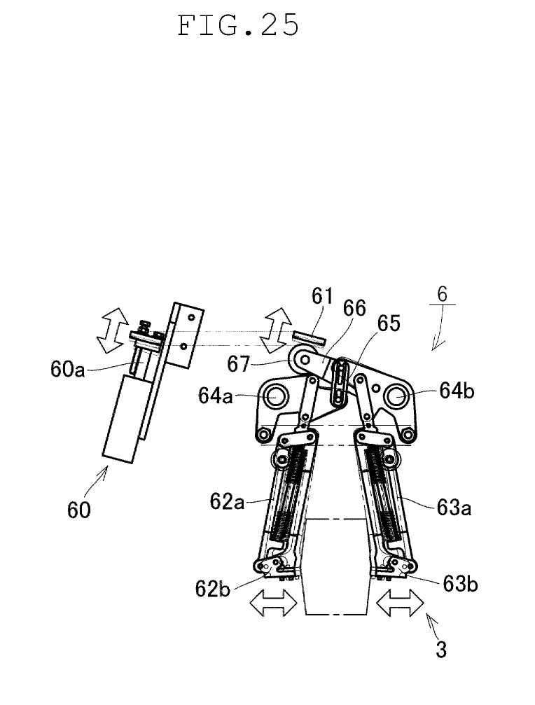

When the opening/closing plate 61 is moved upward by the cylinder 60 as viewed in FIG. 25, the roller 67 mounted on a distal end of lever 66 is also moved upward, whereby the holders 62a and 63a are moved inward via the link 65 with the result that the distance between the grips 62b and 63b of the holders 62a and 63a is reduced.

In an opposite manner, when the opening/closing plate 61 is moved downward by the cylinder 60 as viewed in FIG. 25, the roller 67 is also moved downward, whereby the holders 62a and 63a are moved outward via the link 65 with the result that the distance between the grips 62b and 63b of the holders 62a and 63a is increased. Thus, the distance between the grips 62b and 63b (the intergrip distance) is suitably adjustable by adjusting the telescopic movement of the cylinder head 60a of the cylinder 60.

The paired grips 3 holding the packaging bag a sectorially opened at the opening station (the second station) are intermittently moved to the subsequent opening shaping station (the third station) where the opening shaping step (the third step) is carried out. Provided at the opening shaping station is the spatula inserting mechanism 7 forming the crest on the sectorially opened packaging bag a held by the paired grips 3 to thereby adjust the opening shape.

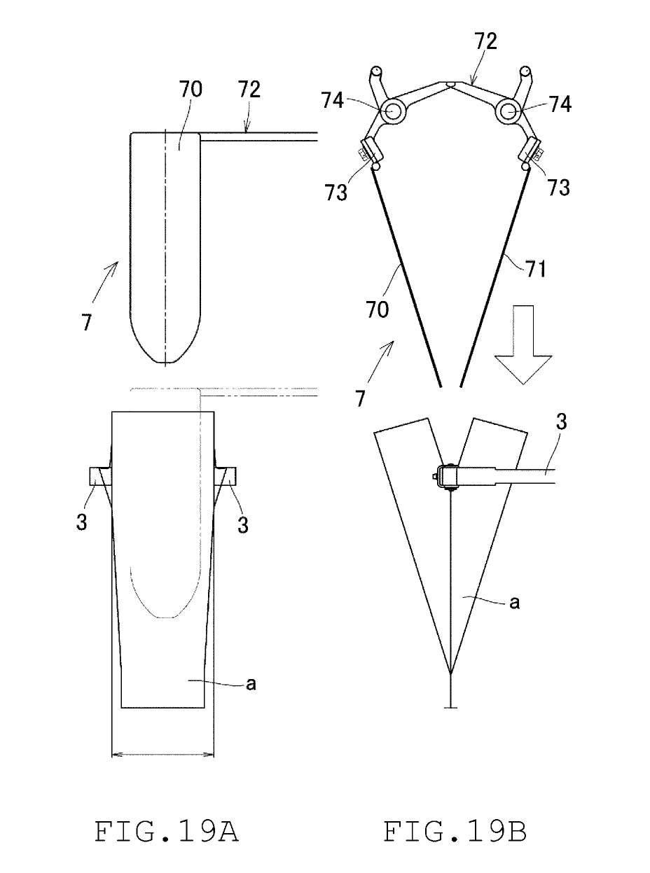

As illustrated in FIGS. 19A and 19B, the spatula inserting mechanism 7 in the embodiment includes two spatulas 70 and 71, supports 72 respective supporting the spatulas 70 and 71 so that the spatulas 70 and 71 are openable and closable, an elevating device (not illustrated) moving the supports 72 upward and downward inside and outside the packaging bag a, and actuators (not illustrated) respectively opening and closing distal ends 73 of the supports 72 about support points 74.

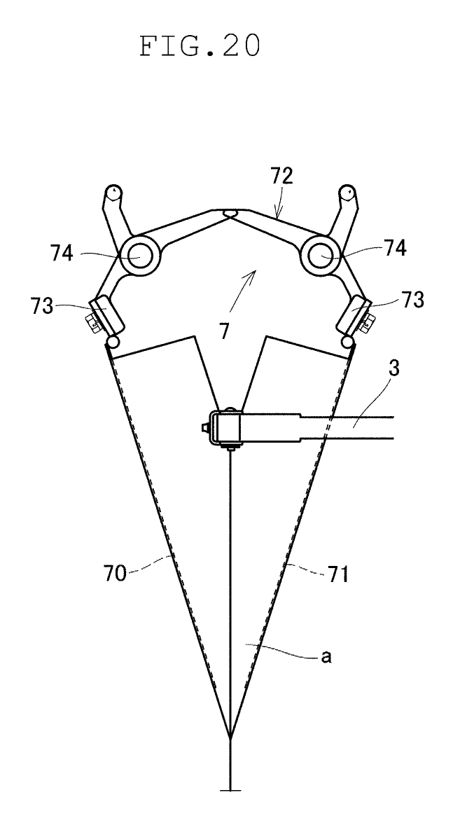

The spatulas 70 and 71 are openable and closable in order that the spatulas 70 and 71 may be prevented from being caught when inserted through the bag mouth c of the packaging bag a and further in order that the crests may be reliably formed. As illustrated in FIG. 20, the spatulas 70 and 71 inserted through the bag mouth c come into face-to-face contact with the inner surface of the packaging bag a thereby to respectively form the crests by widthwise edges, whereby the packaging bag a is shaped so that the triangle sandwich Z can be packed in the packaging bag a more expertly. Furthermore, after having come into face-to-face contact with the inner surface of the packaging bag a and formed the crests, the spatulas 70 and 71 are moved upward by the elevating device to be departed from the interior of the packaging bag a and returned to the respective initial positions. Furthermore, it is preferable that an opening detection is carried out in this step.

The paired grips 3 holding the packaging bag a formed with the crests at the opening shaping station (the third station) are intermittently moved to the packing station (the fourth station) where the subsequent packing step (the fourth step) is carried out.

Furthermore, the packaging machine 1 is controlled so that the intergrip distance of the paired grips 3 is adjusted at the fourth station by the aforementioned intergrip distance adjusting mechanism 6 in the insertion of the triangle sandwich Z into the sectorially opened packaging bag a held by the paired grips 3.

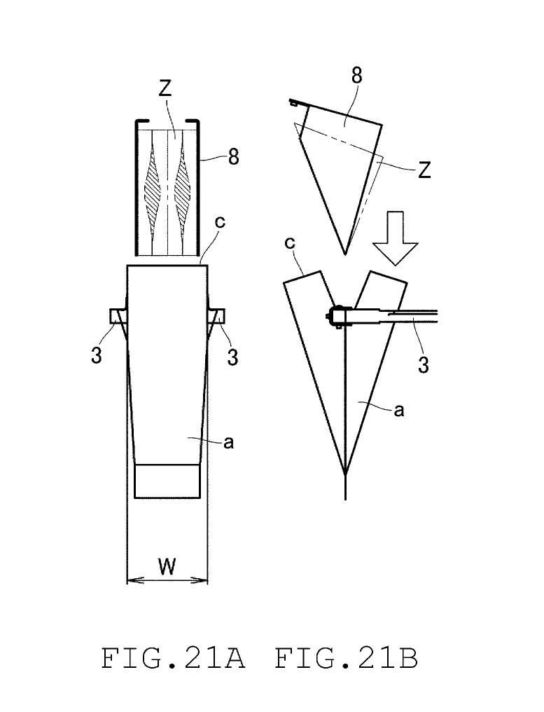

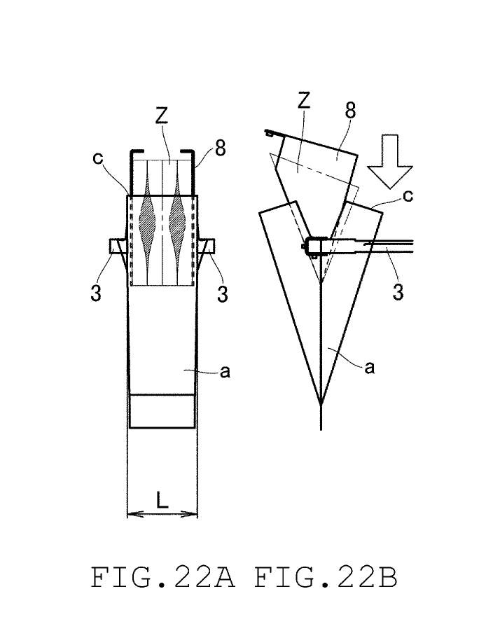

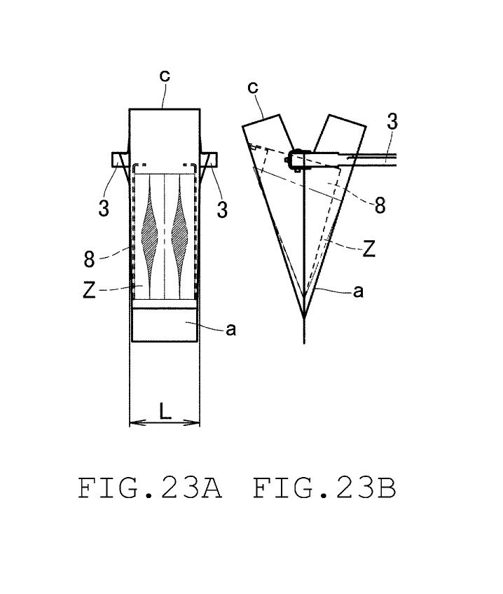

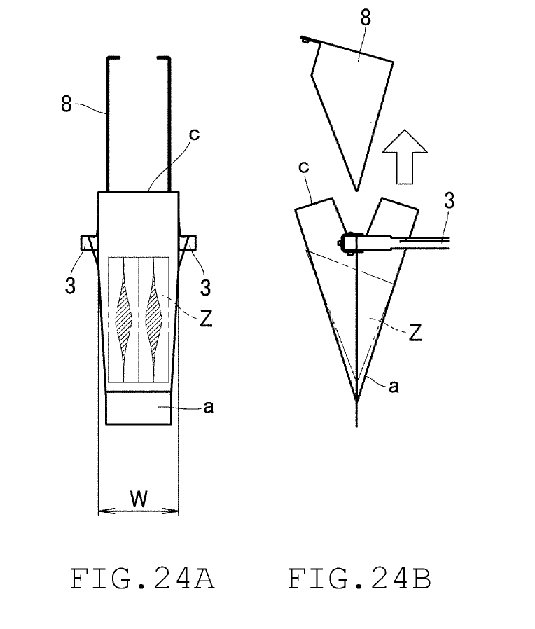

More specifically, as illustrated in FIGS. 21A and 21B, reference symbol “W” designates the intergrip distance before insertion. The intergrip distance is set to L that is smaller than W when a robot hand 8 of a triangle sandwich packing device 100 is inserted through the bag mouth c as illustrated in FIGS. 21A and 21B, when the robot hand 8 is inserted into the bag mouth c as illustrated in FIGS. 22A and 22B, and when the triangle sandwich Z is being put into the packaging bag a with the robot hand 8 having entered the inside of the packaging bag a, as illustrated in FIGS. 23A and 23B. The intergrip distance is returned to W after the robot hand 8 has been departed from the interior of the packaging bag a, as illustrated in FIGS. 24A and 24B. Thus, the triangle sandwich Z can be packed in the packaging bag a more smoothly and more expertly by adjusting the intergrip distance at the time of the packing of the triangle sandwich Z.

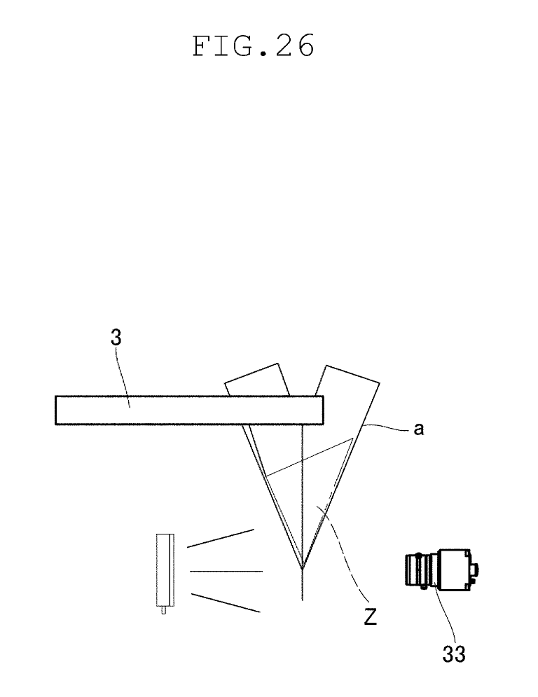

Furthermore, the inspection step (the fifth step) of inspecting the packing of the triangle sandwich Z in the packaging bag a is carried out at the fifth station. More specifically, as illustrated in FIG. 26, determination by means of an image is made by an image determination device 33 as to whether or not the triangle sandwich Z has been firmly packed into the inside of the packaging bag a.

The triangle sandwich Z packed into the packaging bag a is discharged from the packaging machine P at the final sixth station (the sixth step). More specifically, the packaging bag a enclosing the triangle sandwich Z is discharged out of the packaging machine P by the conveyor 3 provided outside the packaging machine P.

In the packaging machine P, packaged products produced by a process involving the working up to the packing of the triangle sandwiches Z in the specially shaped packaging bags a are mass-producible by executing the above-described sequence of packing process for the packaging bag a held by the paired grips 3 intermittently moved by the intermittent rotation of the mover (the disc rotator).

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A triangle sandwich packaging machine comprising:
paired grips provided for holding vicinities of both sides of a bag mouth of a triangle sandwich packaging bag;
a mover intermittently moving the paired grips in every one of packaging stations; and
a spatula inserting mechanism provided for forming a crest on the triangle sandwich packaging bag held by the paired grips to shape an opening.

2. The machine according to claim 1, wherein the spatula inserting mechanism has a plurality of spatulas each configured to be openable and closable.

3. A method of packaging a triangle sandwich by a triangle sandwich packaging machine including paired grips provided for holding vicinities of both sides of a bag mouth of a triangle sandwich packaging bag, a mover intermittently moving the paired grips in every one of packaging stations, and a spatula inserting mechanism provided for forming a crest on the triangle sandwich packaging bag held by the paired grips to shape an opening, the method comprising:
a moving step of intermittently moving the paired grips holding the triangle sandwich packaging bag in every one of the packaging stations;
an opening step of opening the triangle sandwich packaging bag into a sectorial shape; and
a spatula inserting step of forming a crest on the triangle sandwich packaging bag held by the paired grips to shape an opening and inserting a spatula for shaping the opening.
